(19) United States
(12) Patent Application Publication
(10) Pub. No.: US 2024/0397173 A1
(43) Pub. Date: Nov. 28, 2024

(54) CAMERA BALLS

(71) Applicant: Evan S. Greenberg, Lake Hopatcong, NJ (US)

(72) Inventor: Evan S. Greenberg, Lake Hopatcong, NJ (US)

(21) Appl. No.: 18/794,895

(22) Filed: Aug. 5, 2024

Related U.S. Application Data
(63) Continuation of application No. 16/988,441, filed on Aug. 7, 2020.
(60) Provisional application No. 62/922,417, filed on Aug. 8, 2019.

(51) Int. Cl. H04N 23/51; G03B 17/02; H04N 23/50

(52) U.S. Cl. CPC H04N 23/51; G03B 17/02; H04N 23/555

(57) ABSTRACT

A camera ball can include a housing body defining at least one optical opening for a camera in a front side. The camera ball can include a plurality of protrusions extending outwardly from the housing body.

### CROSS-REFERENCE TO RELATED APPLICATIONS

This application is a continuation of U.S. patent application Ser. No. 16/988,441 filed Aug. 7, 2020, which claims priority to and the benefit of U.S. Provisional Application No. 62/922,417, filed Aug. 8, 2019. The entire contents of each of the foregoing are incorporated herein by reference in their entirety.

### FIELD

This disclosure relates to camera balls, e.g., for use in dryer vent inspection and/or any other suitable ducting inspection.

### BACKGROUND

Existing cameras, e.g., for ducting inspection, are not easily maneuverable clockwise and counterclockwise in situ, can get caught on ducting seams and corners, and can require long cables if wired. Existing wireless cameras require internet connections and can lose connection in metal ductwork and can experience interference from electrical appliances (e.g., microwave ovens), for example.

Such conventional methods and systems have generally been considered satisfactory for their intended purpose. However, there is still a need in the art for improved cameras for ducting inspection. The present disclosure provides a solution for this need.

### SUMMARY

In accordance with at least one aspect of this disclosure, a camera ball can include a housing body defining at least one optical opening for a camera in a front side. The camera ball can include a plurality of protrusions extending outwardly from the housing body.

In certain embodiments, the protrusions can be integrally formed with the housing body. In certain embodiments, the housing body can be spheroidal.

The plurality of protrusions can be or include one or more circumferential ribs extending radially outwardly from the housing body. The one or more circumferential ribs can include a plurality of symmetrically spaced circumferential ribs that extend radially outwardly starting from the optical opening, extending circumferentially and ending at a rear location of the housing body.

In certain embodiments, the housing body can include a rear opening diametrically opposite the camera opening. The rear location can be the rear opening, for example.

The housing body can further include one or more light openings between one or more pairs of adjacent circumferential ribs and configured to receive a light. The one or more light openings can include a light opening disposed between each adjacent pair.

The one or more light openings can be concentrically disposed around the camera opening. The rear opening can be configured to allow an attachment member to extend therethrough to allow attachment of the camera ball to a duct inspection rod.

The housing body can include an antenna hole defined in a rear side of the housing body and configured to allow an antenna to extend away from a direction of the camera. In certain embodiments, the housing body can define a plurality of interior features configured to nest each internal component therein.

In certain embodiments, the housing body can include a front portion and a rear portion configured to be attached together. The front portion and the rear portion can be configured to be fastened together with one or more fasteners.

In certain embodiments, the camera ball can include the camera and one or more lights. The camera and one or more lights can be disposed within the housing body such that the camera can view through the optical opening and each light is disposed within the one or more light openings.

In certain embodiments, the camera ball can include the attachment member partially disposed within housing body and extending from rear opening. In certain embodiments, the attachment member can be a threaded rod.

In certain embodiments, the camera ball can include a wireless transceiver and antenna. The wireless transceiver can be disposed within the housing body and can be operatively connected to the camera to receive imaging data therefrom. The wireless transceiver can be operatively connected to the antenna to wirelessly transmit data. The antenna can pass through the antenna hole to extend from the housing body. In certain embodiments, the wireless transceiver can be a 5.8 GHz transceiver.

In certain embodiments, the camera ball can include a controller disposed within the housing body and configured to control one or more or all of the camera, the one or more lights, and the wireless transceiver, a power switch operatively connected to the controller to turn the controller on or off, the power switch accessible from an outside of the housing body, a rechargeable battery disposed within the housing body, and a charging port accessible from the outside of the housing body. Any other suitable components are contemplated herein.

In accordance with at least one aspect of this disclosure, a wireless camera ball can include a housing body defining at least one optical opening for a camera in a front side and an antenna hole in a rear side opposite the front side, a wireless transceiver disposed within the housing body and operatively connected to the camera to receive imaging data therefrom, and an antenna. The wireless transceiver can be operatively connected to the antenna to wirelessly transmit data. The antenna can pass through the antenna hole to extend from the housing body and can be configured to directly connect with a wireless monitor antenna to directly send imaging data to a wireless monitor module.

In accordance with at least one aspect of this disclosure, an inspection system can include a wireless camera ball having a housing body defining at least one optical opening for a camera in a front side and an antenna hole in a rear side opposite the front side, a wireless transceiver disposed within the housing body and operatively connected to the camera to receive imaging data therefrom, and an antenna. The wireless transceiver can be operatively connected to the antenna to wirelessly transmit data. The antenna can pass through the antenna hole to extend from the housing body. Any other suitable camera ball as disclosed herein, e.g., as described above, is contemplated herein. The inspection system can include a wireless monitor module configured to wirelessly connect to the wireless camera ball directly via the antenna to receive real-time imaging data from the camera.

In accordance with at least one aspect of this disclosure, a dryer vent inspection system kit includes a camera ball. In certain embodiments, the camera ball includes a single camera configured to capture a live video of an interior of a dryer vent, a plurality of lights configured to illuminate the interior of the dryer vent during an inspection, and a wireless transceiver configured to transmit the live video from the single camera to a remote device to display the live video.

In certain embodiments, the camera ball can also include a forward housing portion having a central hole defined therethrough for receiving a camera lens, a plurality of light apertures defined therethrough and arranged circumferentially about the central opening, and a plurality of ribs defined on the forward housing portion, extending from the central opening to a rear of the forward housing portion, and arranged circumferentially about the central opening, protruding outward from the forward housing portion. The plurality of light apertures can be disposed between the plurality of ribs such that the plurality of light apertures and the plurality of ribs alternate in the circumferential direction. In certain embodiments, the forward housing portion can further define an interior space shaped and configured to receive a portion of the single camera, a portion of the plurality of lights, a portion of the wireless transceiver, and a portion of an electronics assembly therein. The interior space can also include a plurality of fastener apertures disposed therein for receiving a respective fastener.

The camera ball can also include a rear housing portion having a central hole defined therethrough for receiving an attachment member, an aperture defined therethrough for receiving an antenna of the wireless transceiver, an aperture defined therethrough configured for receiving a charging cable to charge the single camera or one or more portions of the electronics assembly, and a plurality of ribs defined on the rear housing portion, extending from the central opening to a rear of the rear housing portion, and arranged circumferentially about the central opening, protruding outward from the rear housing portion. The rear housing portion can further define an interior space shaped and configured to receive a portion of the single camera, a portion of the plurality of lights, and a portion of the electronics assembly, such that when the forward housing portion and the rear housing portion are assembled to one another, the interior space of the forward housing portion and the interior space of the rear housing portion form a camera ball interior to nest and encase the single camera, the plurality of lights, the wireless transceiver, and the electronics assembly therein. The interior space can also include a plurality of fastener apertures disposed therein for receiving a respective fastener.

In certain embodiments, the wireless transceiver can be operatively connected to the single camera to receive imaging data therefrom and configured to wirelessly communicate the imaging data to the remote device.

In certain embodiments, the electronics assembly can include a controller disposed configured to control the single camera, the plurality of lights, the wireless transceiver, a power switch operatively connected to the controller to turn the controller on or off, the power switch being accessible from an outside of a housing body, a rechargeable battery disposed within the housing body, and a charging port accessible from the outside of the housing body through the charging aperture.

The camera ball can include a plurality of fasteners, each respective fastener extending through a respective fastener aperture of the rear housing portion into a respective fastener aperture of the forward housing portion to secure the rear housing portion to the forward housing portion.

The kit can also include the attachment member partially inserted into the central opening of the rear housing portion and secured with a fastener on the interior of the camera ball such that a portion of the attachment member extends outward from the rear housing portion. In certain embodiments, the attachment member is a threaded attachment member and the fastener can be a threaded fastener threaded onto the attachment member.

The kit can also include a flexible spring having a first end and a second end, the first end threaded onto the attachment member and the second end having a quick release female fitting operatively connected thereto for selectively coupling the inspection system with a plurality of different duct inspection rods or duct inspection rod adapters.

The kit can also include an inspection rod selectively coupled to the camera ball via the quick release female fitting for maneuvering the camera ball through the interior of the dryer vent during the inspection.

In certain embodiments, the camera ball, the attachment member, and the flexible spring are configured to, together, be selectively removed from and attached to a plurality of different duct inspection rods or duct inspection rod adapters.

In certain embodiments, the plurality of lights can be separate from the single camera.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is an isometric view of an embodiment of a camera ball in accordance with this disclosure;

FIG. 2A is a front view of an embodiment of a front portion of an embodiment of a housing body in accordance with this disclosure, showing an exterior thereof;

FIG. 2B is a rear view of the embodiment of FIG. 2A, showing an interior thereof;

FIG. 2C is a rear perspective view of the embodiment of FIG. 2A;

FIG. 2D is a front perspective view of the embodiment of FIG. 2A;

FIG. 2E is a side elevation view of the embodiment of FIG. 2A;

FIG. 3A is a rear view of an embodiment of a rear portion of an embodiment of a housing body in accordance with this disclosure, showing an exterior thereof;

FIG. 3B is a front view of the embodiment of FIG. 3A, showing an interior thereof;

FIG. 3C is a side elevation view of the embodiment of FIG. 3A;

FIG. 4 is a plan view of an inside of the front portion and the rear portion of the embodiments of FIGS. 2B and 3B;

FIG. 5 is a rear perspective view of the embodiment of FIG. 3A, showing an attachment member attached to the rear portion of the housing body and extending through a rear opening of the rear portion;

FIG. 6A shows a perspective view of the embodiment of FIG. 5 attached by the attachment member to a flexible extension rod, shown in a straight position;

FIG. 6B is a perspective view of the embodiment of FIG. 6A, shown in a deflected position;

FIG. 7 is a perspective view of an embodiment of internal components of the camera ball;

FIG. 8A is a perspective view of a camera, a light array, and wireless transceiver (with antenna attached thereto) nested within the front portion of the embodiment of a housing body of FIG. 2B and attached to a controller;

FIG. 8B is a perspective view the attachment member and a power switch (connected to the controller) nested within the rear portion of the housing body of FIG. 3B;

FIG. 9A is a plan view an embodiment of the camera ball attached to a flexible extension rod, showing an antenna extending rearwardly from the housing body of the camera ball;

FIG. 9B is a rear perspective view of the embodiment of FIG. 9A; and

FIG. 10 is a schematic diagram of an embodiment of a camera ball in use in a duct system, shown wirelessly directly connected to an embodiment of a wireless monitor.

### DETAILED DESCRIPTION

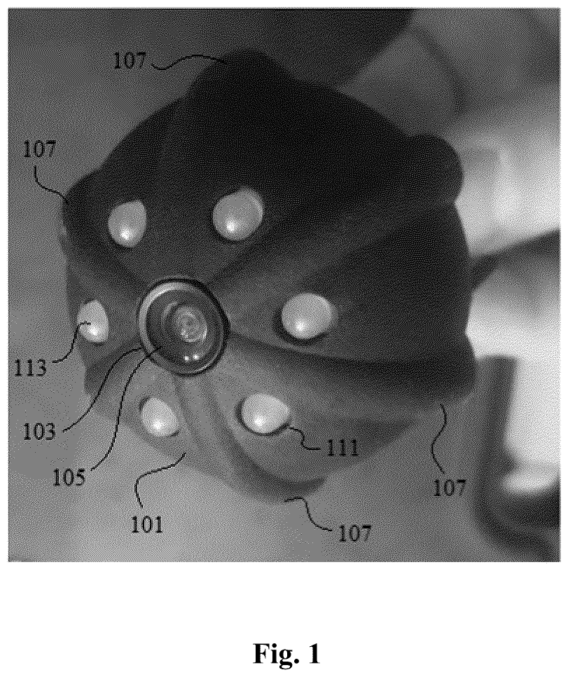

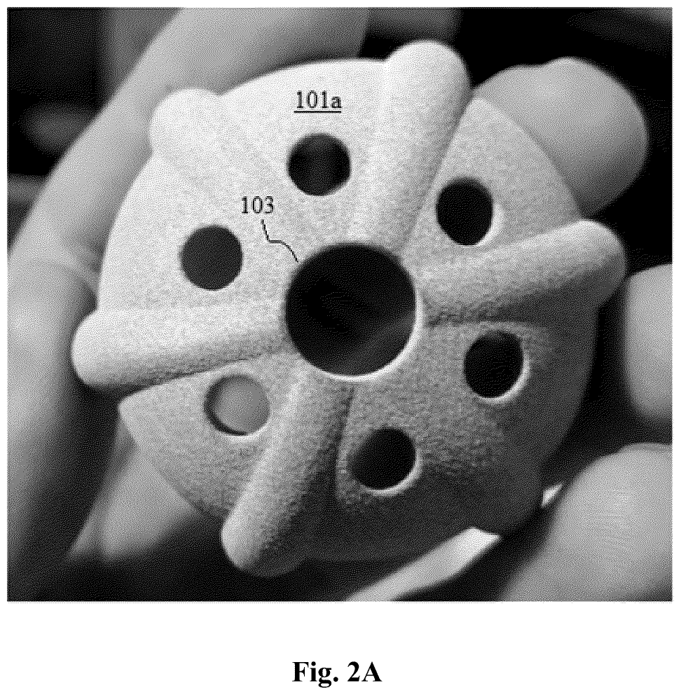

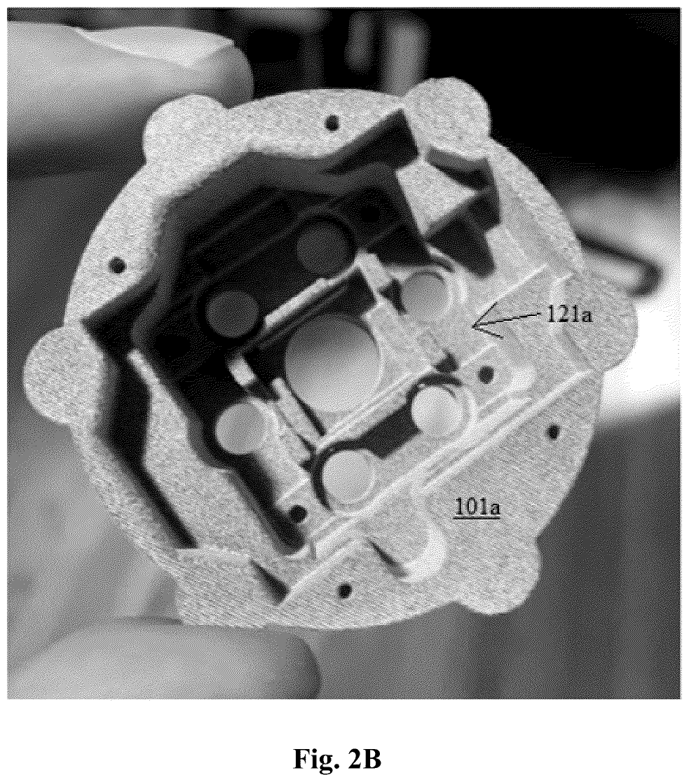

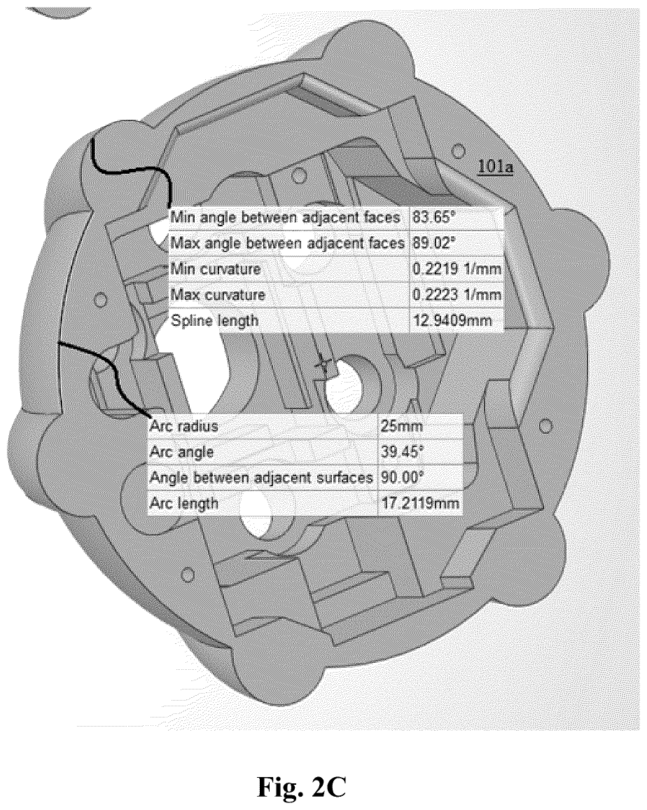

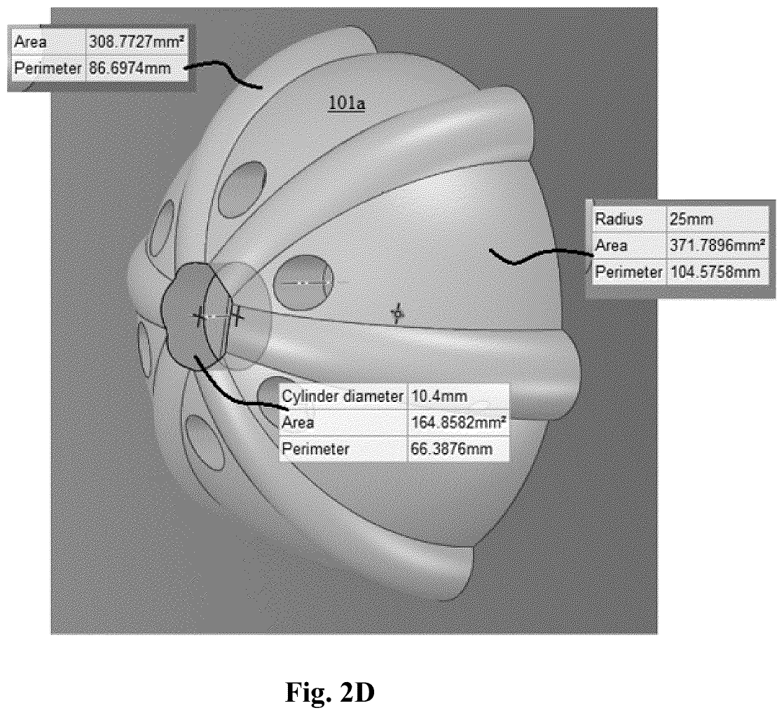

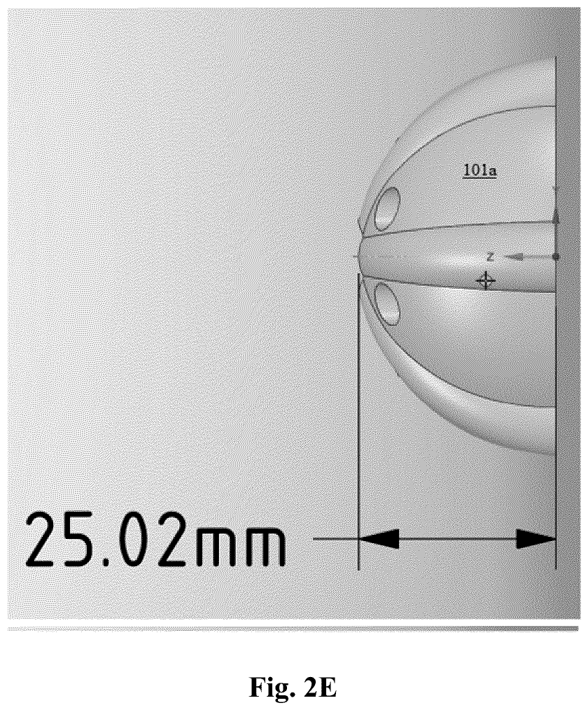

Reference will now be made to the drawings wherein like reference numerals identify similar structural features or aspects of the subject disclosure. For purposes of explanation and illustration, and not limitation, an illustrative view of an embodiment of a camera ball in accordance with the disclosure is shown in FIG. 1 and is designated generally by reference character 100. Other embodiments and/or aspects of this disclosure are shown in FIGS. 2A-10. Certain embodiments described herein can be used for inspection (e.g., of dryer vents).

Referring to FIGS. 1-10 generally, certain embodiments of camera ball 100 can include a housing body 101 defining at least one optical opening 103 for a camera 105 in a front side (e.g., as shown in FIGS. 1 and 2A-2E). The camera ball 100 can include a plurality of protrusions 107 (e.g., six protrusions 107 as shown) extending outwardly from the housing body 101. Any suitable number of protrusions 107 is contemplated herein.

In certain embodiments, the protrusions 107 can be integrally formed with the housing body 101, e.g., as shown. In certain embodiments, the housing body 101 can be spheroidal (e.g., a sphere with protrusions 107 extending therefrom), e.g., as shown. Any suitable protrusion type (e.g., integral or separately attached) and any suitable protrusion shape (e.g., semicircular cross-sectional shape as shown and/or any other suitable outward extensions for ducting inspections) are contemplated herein. Any suitable shape (e.g., for ducting inspection) for the housing body 101 is contemplated herein.

The plurality of protrusions 107 can be or include one or more circumferential ribs (e.g., as shown) extending radially outwardly from the housing body 101. The one or more circumferential ribs can include a plurality of symmetrically spaced circumferential ribs that extend radially outwardly starting from the optical opening 103, extending circumferentially and ending at a rear location of the housing body 101, e.g., as shown.

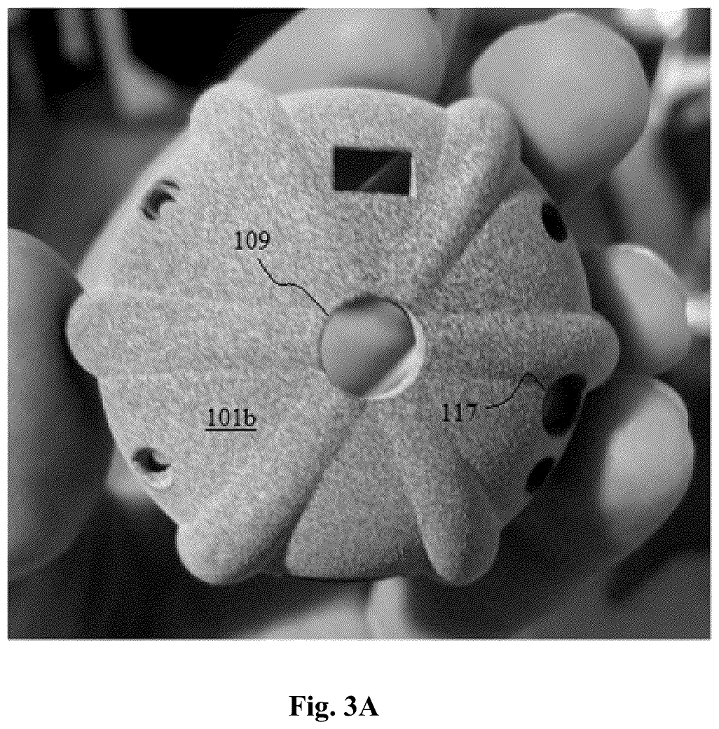

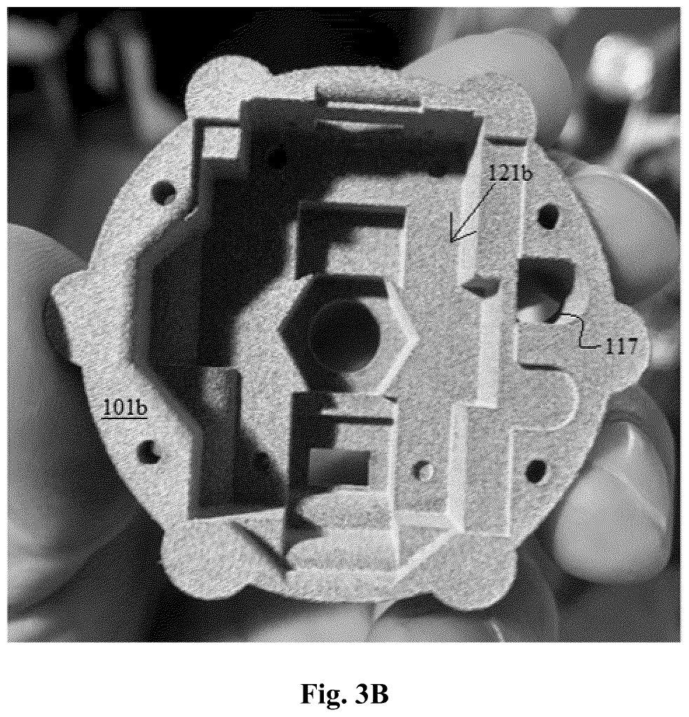

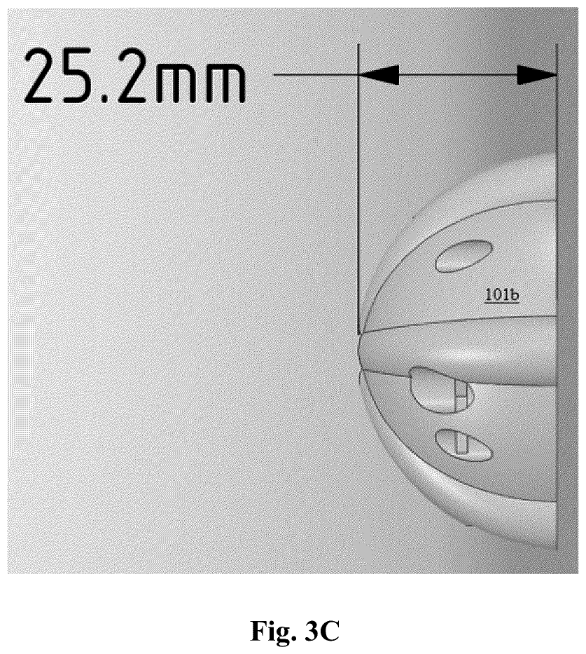

In certain embodiments, referring additionally to FIGS. 3A-3C, the housing body 101 can include a rear opening 109 diametrically opposite the camera opening 103. The rear location (where the protrusions 107 converge at a rear side) can be the rear opening 109, e.g., as shown, for example.

The housing body 101 can further include one or more light openings 111 between one or more pairs of adjacent protrusions (e.g., circumferential ribs) and configured to receive a light 113. The one or more light openings 111 can include a light opening 111 disposed between each adjacent pair of protrusions 107, e.g., as shown.

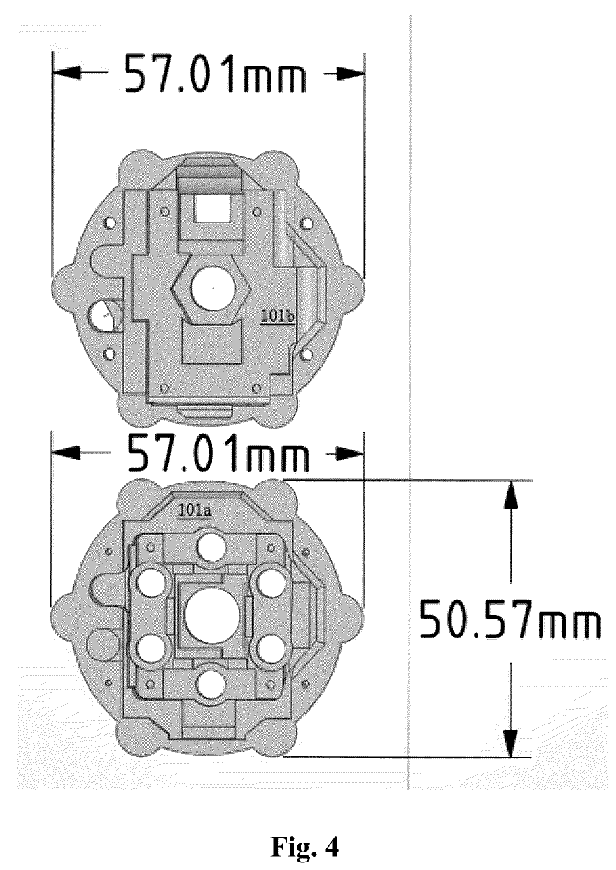

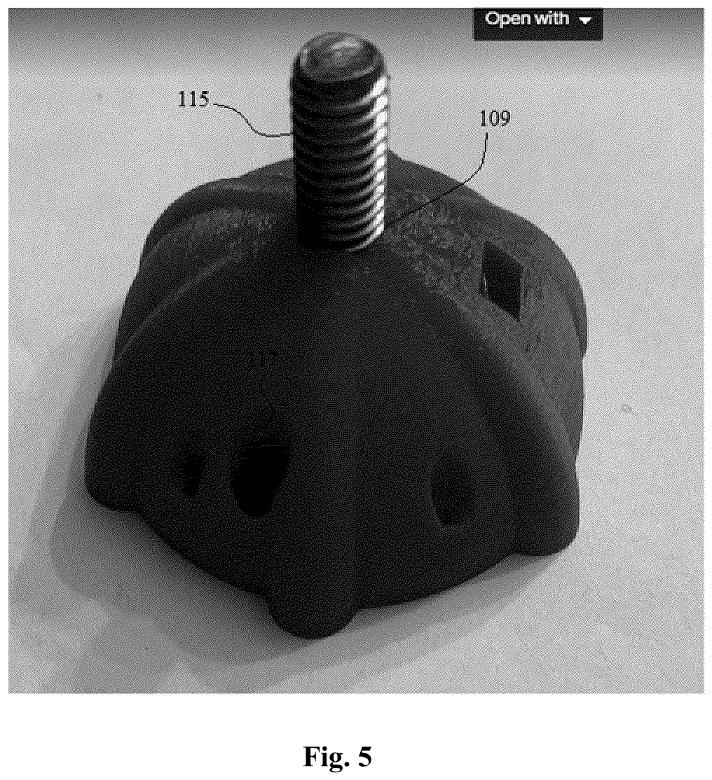

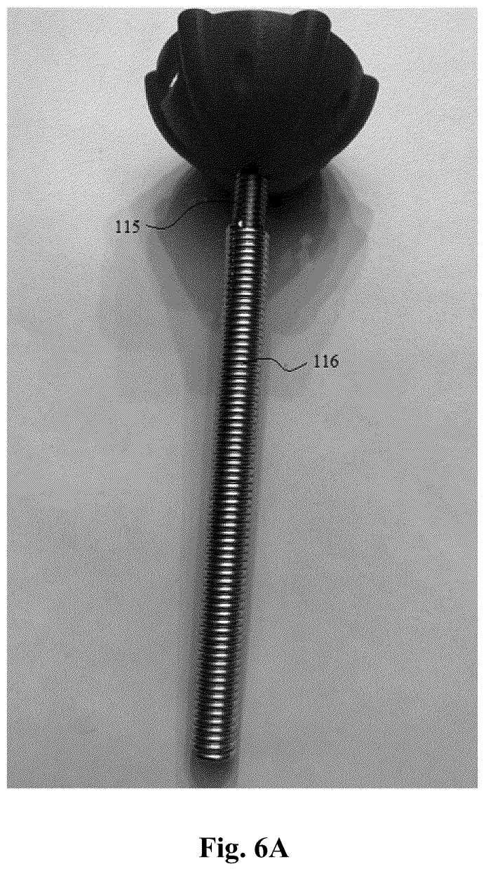

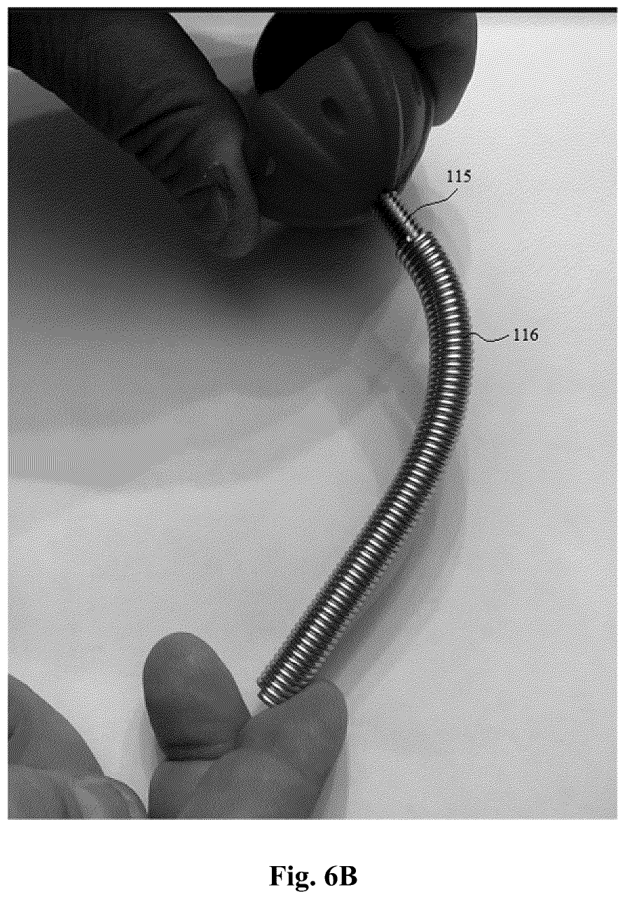

Referring additionally to FIG. 4, the one or more light openings 111 can be concentrically disposed around the camera opening 103, e.g., a shown. Referring additionally to FIGS. 5, 6A, and 6B, the rear opening 109 can be configured to allow an attachment member 115 (e.g., a threaded rod) to extend therethrough to allow attachment of the camera ball 100 to a duct inspection rod (e.g., a flexible rod 116). In certain embodiments, the attachment member 115 can be a female member and does not need to extend through the rear opening 109.

in certain embodiments, the camera ball 100 can be wireless. However, it is contemplated that hard wired communication may be used instead of or in addition to wireless communication.

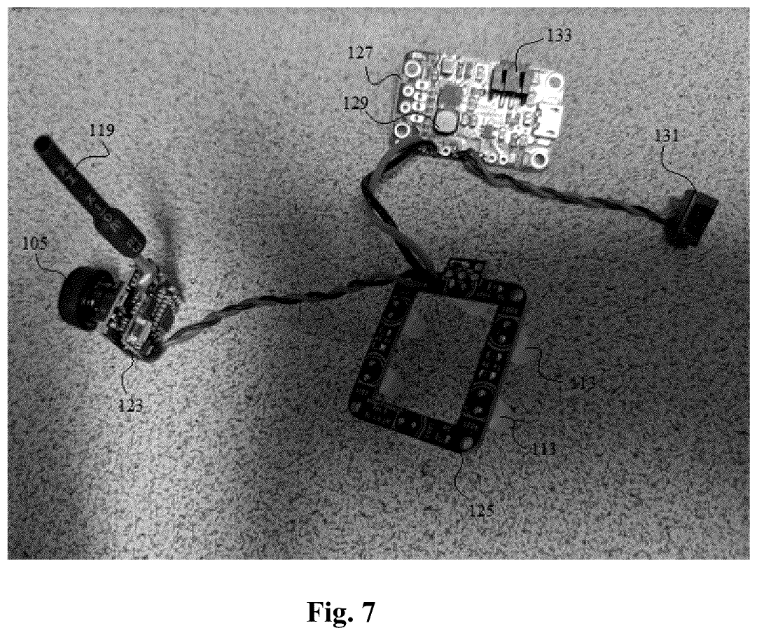

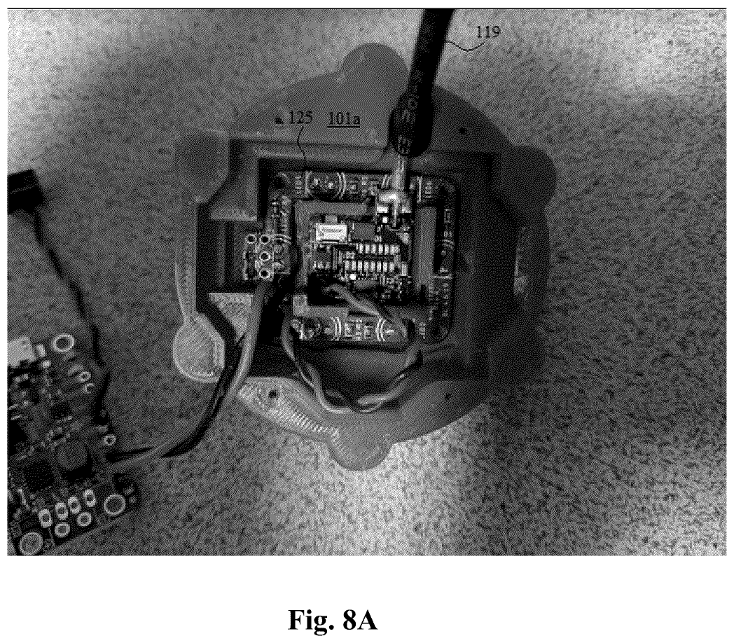

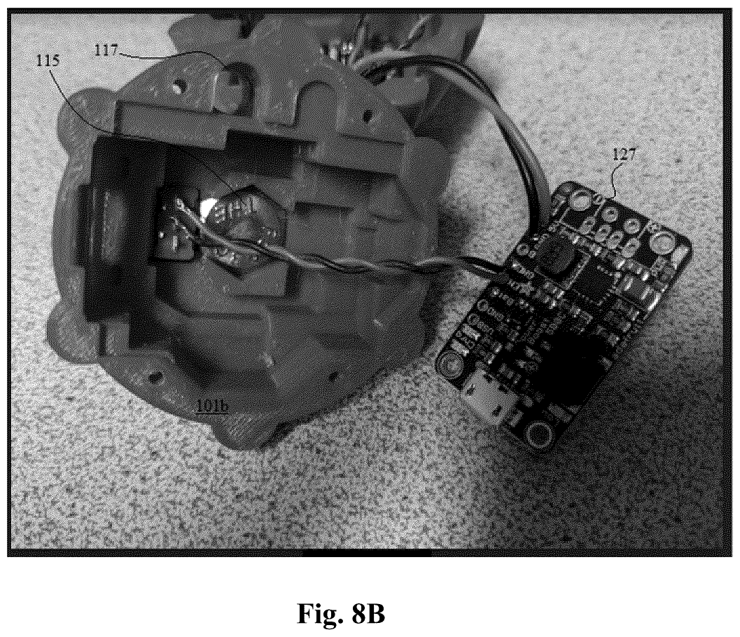

In certain embodiments, the housing body 101 can include an antenna hole 117 defined in a rear side of the housing body 101 and configured to allow an antenna 119 to extend away from a direction of the camera 105. In certain embodiments, the housing body 101 can define a plurality of interior features 121a, 121b (e.g., as shown in FIG. 2B, 3B, 4) configured to nest each internal component 123, 125, 127, 129, 131 (e.g., as shown in FIG. 7) therein (e.g., as shown in FIGS. 8A and 8B).

In certain embodiments, the housing body 101 can include a front portion 101a (e.g., a front half) and a rear portion 101b (e.g., a rear half) configured to be attached together. The front portion 101a and the rear portion 101b can be configured to be fastened together with one or more fasteners (e.g., screws, clips, etc.). Any suitable division between front portion and rear portion is contemplated herein. Any other suitable number and/or division of portions are contemplated herein. In certain embodiments, the housing body 101 can be unitary.

In certain embodiments, the camera ball 100 can include the camera 105 and one or more lights 113 (e.g., a light array chip 125). The camera 100 and one or more lights 113 can be disposed within the housing body 101 (e.g., first portion 101a as shown in FIG. 8A) such that the camera 105 can view through the optical opening 103 and each light 113 is disposed within the one or more light openings 111. Any other suitable arrangement is contemplated herein.

In certain embodiments, the camera ball 100 can include the attachment member 115 partially disposed within housing body 101 (e.g., in rear portion 101b as shown in FIG. 8B) and extending from rear opening 109. In certain embodiments, the attachment member 115 can be a threaded rod. Any other suitable attachment member, male or female, is contemplated herein.

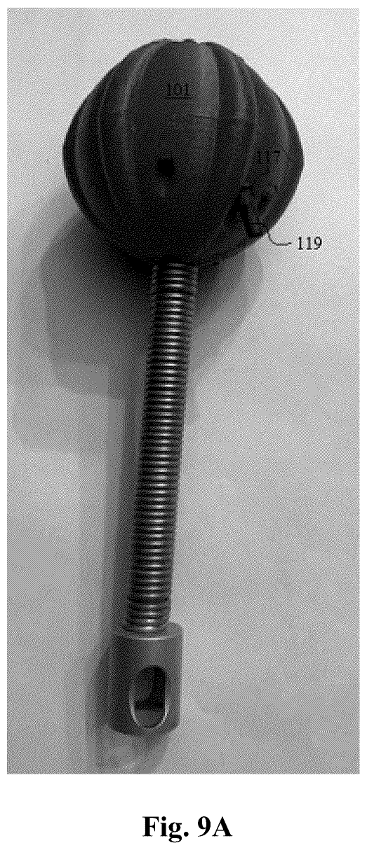

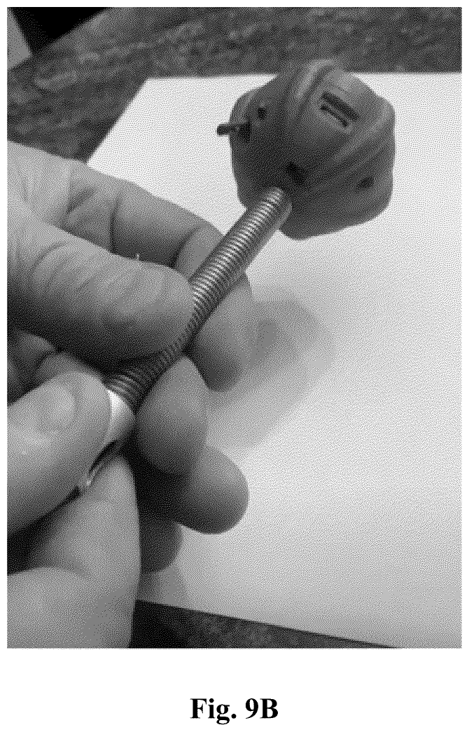

In certain embodiments, the camera ball 100 can include a wireless transceiver 125 and antenna 119. The wireless transceiver 125 can be disposed within the housing body 101 (e.g., front portion 101a) and can be operatively connected to the camera 105 to receive imaging data therefrom. The wireless transceiver 125 can be operatively connected to the antenna 119 to wirelessly transmit data. Referring additionally to FIGS. 9A and 9B, the antenna 119 can pass through the antenna hole 117 to extend from the housing body 101 (e.g., rear portion 101b), e.g., in a direction toward open air out of the duct where the camera ball was inserted.

In certain embodiments, the wireless transceiver 125 can be a 5.8 GHz transceiver. This frequency can be particularly advantageous for maintaining real time, video streaming quality connection within metal ductwork for example. Any other suitable frequency is contemplated herein.

In certain embodiments, the camera ball 100 can include a controller 127 disposed within the housing body 101 (e.g., in either or both of portions 101a, 101b) and configured to control one or more or all of the camera 105, the one or more lights 113, and the wireless transceiver 125. A power switch 131 can be operatively connected to the controller 127 to turn the controller 127 on or off. The power switch 131 can be accessible from an outside of the housing body 101 (e.g., via a power switch hole in the rear portion 101b). The camera ball 100 can include a rechargeable battery 129 disposed within the housing body 101 (e.g., attached to the controller 127) and a charging port 133 which can be accessible from the outside of the housing body 101 (e.g., via a charge port hole in the rear portion 101b). Any other suitable components are contemplated herein.

The controller 127, the wireless transceiver, 125, and any other suitable component (e.g., logic components) can include any suitable computer hardware and/or software module(s) configured to perform the disclosed function and/or any other suitable function as appreciated by those having ordinary skill in the art. While certain figures may disclose one or more dimensions for certain embodiments, any suitable dimensions can be used for any suitable embodiments and/or for any suitable application.

In accordance with at least one aspect of this disclosure, a wireless camera ball, e.g., camera ball 100, can include a housing body 101 defining at least one optical opening for a camera in a front side and an antenna hole in a rear side opposite the front side, a wireless transceiver disposed within the housing body and operatively connected to the camera to receive imaging data therefrom, and an antenna. The wireless transceiver can be operatively connected to the antenna to wirelessly transmit data. The antenna can pass through the antenna hole to extend from the housing body and can be configured to directly connect with a wireless monitor antenna to directly send imaging data to a wireless monitor module.

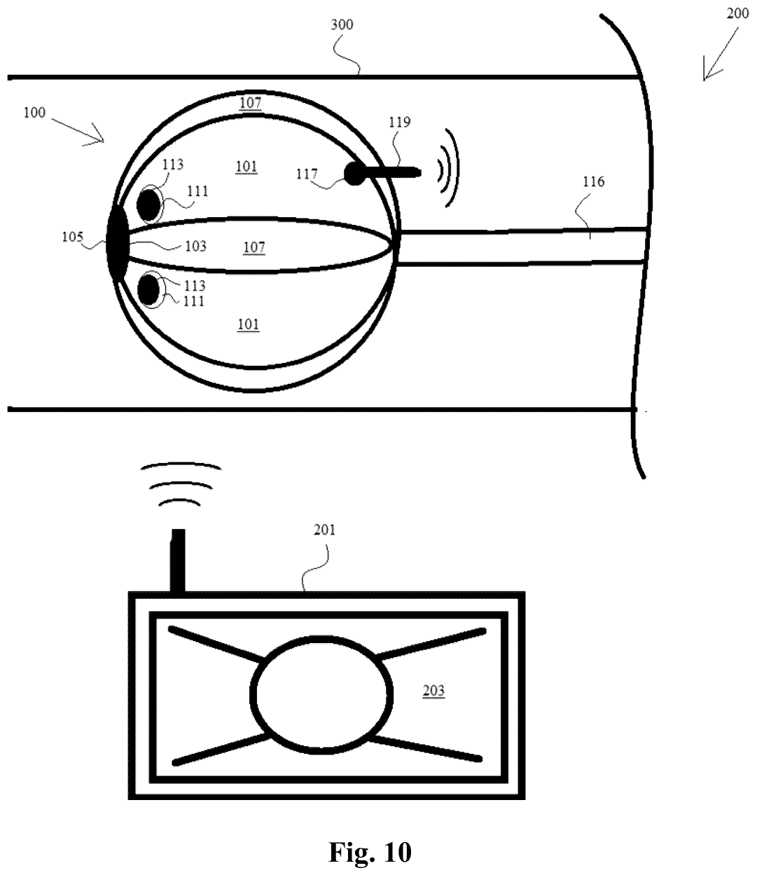

In accordance with at least one aspect of this disclosure, an inspection system 200, e.g., as shown in FIG. 10 in use in ducting 300, can include a wireless camera ball, e.g., camera ball 100, having a housing body 101 defining at least one optical opening 103 for a camera 105 in a front side and an antenna hole 117 in a rear side opposite the front side, a wireless transceiver 125 disposed within the housing body 101 and operatively connected to the camera 105 to receive imaging data therefrom, and an antenna 119. The wireless transceiver 125 can be operatively connected to the antenna to wirelessly transmit data. The antenna 119 can pass through the antenna hole 117 to extend from the housing body 101. Any other suitable camera ball as disclosed herein, e.g., as described above, is contemplated herein.

The inspection system 100 can include a wireless monitor module 201 configured to wirelessly connect to the wireless camera ball directly via the antenna 119 to receive real-time imaging data from the camera 105. The wireless monitor module 201 can include any suitable wireless hardware (e.g., a display 203, a wireless transceiver, an antenna). In certain embodiments, the wireless monitor module 201 can include any suitable hardware and/or software module(s) configured to receive and display imaging data on the display 203, for example. In certain embodiments, the wireless monitor module 201 can include an antenna and a wireless transceiver connected thereto without a display, and the wireless monitor module 201 can be configured to be connected to another device (e.g., a smartphone, a tablet, a laptop, any suitable computerized device, etc.) to allow the device to receive the imaging data and display and/or process the imaging data (e.g., real-time video).

Certain embodiments can include a self-contained round plastic (or any other suitable material) ball with six protruding symmetrical guides to help pass through pipes and navigate around turns (elbows) in both forward and reverse direction, for example. Certain embodiments can include a one touch on and off switch. Certain embodiments can include a 5/16 protruding bolt to attach additional guides, centering device (optional) and a stiff flexible spring (included) to help navigate camera through pipes and around turns. Certain embodiments can include spring threads over the 5/16 bolt on one end, and a female fitting on the other end that connects to snap lock and button lock rods so it can easily be pushed through, pulled through, and rotated clockwise and counter clockwise through vents, chimneys and ducts, both solid and flexible to do color video inspections in light and dark areas, for example.

Certain embodiments can be attached to lint eater rods but may not be able to be rotated counter clockwise with these rods, for example. Certain embodiments can links to a wireless color monitor (e.g., 7 inch screen) with DVR function to take videos and snap shots that can be recorded on a micro SD card and sent to any cell phone, tablet, computer, or printer, for example. To send images direct to any cell phone or tablet you would, an optional antenna to plug into the smart device can be provided. Certain embodiments can link to an optional color wrist watch monitor (e.g., 2.5 inch screen) to do hands free inspections. Certain embodiments can send images to multiple monitors simultaneously. Certain embodiments have been tested to transmit clear color videos and pictures through 60-plus feet of pipe, for example.

Certain embodiments can include a camera, an LED ring consisting of six defused white LED lights, a transmitter, an antenna, a rechargeable battery pack, an integrated charging port, an on/off switch, and a custom made printed circuit board to link everything together providing a power charging circuit for seamless power transition from DC to battery for continuous operation. In certain embodiments, the camera can be a CMOS sensor capable of outputting NTSC/PAL or better resolution, the lights can be an LED ring having 6 Defused white lights for illumination in dark areas (visible or infrared mounted to a custom made printed circuit board, for example), and the transmitter can be a wireless 5.8 GHz transmitter with or without telemetry control mounted to the camera. All bands for RC control can be supported but not limited to other custom protocols.

In certain embodiments, the battery can be a LIPO rechargeable battery to provide power to entire unit. Certain embodiments can include a power charging circuit with an integrated charge port and seamless power transition from DC to battery for continuous operation.

Embodiments can be wireless or wired, for example. Certain embodiments include a compact day/night color camera, a multichannel transmitter and external antenna. The camera can be surrounded by white, diffused LED lights and is powered by a rechargeable, lithium battery. Certain embodiments can include a built-in charging port and a charge indicator light. To conserve battery life, there can be an instant on/off switch that can shut down the entire system.

All circuits can be custom made to fit around/plug into each other which allows for easy installation into a compact ball with built-in glides. Certain embodiments can include a 5/16-18 fitting for easy attachment to a flexible spring as well as a SnapLok, ButtonLok, Gardus fittings, adapters, flexible rods, or other attachments. Certain embodiments can be sized and designed to be easily inserted into any vent, duct, pipe, chimney, or flu, whether they are solid or flexible. When connected to flexible rods, embodiments can easily be maneuvered in all directions, in, out, up, down, left, right, clockwise, counterclockwise, or at any angle manually. Once turned on and inserted into the desired area, embodiments can illuminate, navigate and inspect areas in front, behind, and all around the ball.

In certain embodiments, the signal can be transmitted wirelessly to multiple devices such as a color monitor, wristwatch monitor, DVR, tablet, or smartphone. Embodiments may not include a wifi connection for monitoring, but direct wireless connection. Wifi can result in a loss of signal in certain applications. Certain embodiments may utilize a wifi, Bluetooth, or other suitable connection for any suitable purpose, however. Certain embodiments can have a direct two way communication and can connect to smartphone or other smart device via an adapter.

Using certain embodiments, a user can view and take color snapshots and videos remotely and effortlessly while the device is in or passing through the designated area and/or entire length of any vent, pipe, or chimney/flu. Embodiments can be used for, but not limited to, viewing/photographing, inspection, and determining the condition, integrity, and cleanliness of any vent, duct, pipe, or chimney/flue. Embodiment can be used to locate any obstructions, openings, gaps, leaks, imperfections, restrictions, or any other hazards from the inside without interference or loss of signal.

As disclosed above, certain embodiments can include circuits that are custom made to fit around each other, nest in a housing, plug into each other, and be installed in a compact round ball with built in glides. As disclosed above, certain embodiments can have a 5/16-18 fitting for easy attachment to a spring and or snap lock, button lock, gardus fittings, adapters, attachments, and flexible rods. Certain embodiments can be sized and designed to be easily inserted into any vent, duct, pipe, chimney or flu, solid or flexible. Certain embodiments can be easily maneuvered, up, down, in, out, side to side, left, right, clockwise, counterclockwise at any angles in both forward and reverse directions. Once turned on, embodiments can be inserted and easily navigated to illuminate and inspect everything in front of it, behind it and all around it. The signal can be transmitted wirelessly to multiple devices such as a color monitor, wristwatch monitor, DVR, iPad or cellphone, for example. A user can view, take color snapshots, and videos remotely and effortlessly.

Embodiments can be used for, e.g., inspection, viewing, photographing, and determining the condition, integrity, and cleanliness of all duct work. Embodiments can relocate an obstruction, openings, gaps, leaks, imperfections, restrictions, or any other hazards without any interference or loss of signal. Certain embodiments can utilize a 600TVL Resolution Color Camera, a 5.8 GHz Wireless Video Transmitter, a 5.8 GHz Wireless Monitor, 6 Bright White LED's with optional Diffuser, a 500ma Battery Up to 1 hr Continuous Use (Camera), a 2 hr Battery Life (Monitor), a 5/16-18 Threaded Bolt, and one or more attachments. Any other suitable components are contemplated herein.

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A camera ball, comprising:
a single camera;
a housing body defining a single optical opening for the single camera in a front side of the housing body, wherein the housing body is formed by two or more portions configured to enclose the single camera, wherein the housing body includes a rear opening diametrically opposite the camera opening;
a plurality of protrusions extending outwardly from the housing body, wherein the plurality of protrusions are disposed symmetrically about a center axis of the housing body;
a wireless transceiver operatively connected to the single camera to receive imaging data therefrom;
an attachment member, wherein the attachment member is a bolt, disposed within the rear opening; and
a flexible spring connected to the cameral ball via the attachment member, wherein the flexible spring is threaded onto the attachment member at a first end of the flexible spring and wherein the flexible spring includes a female fitting attached to a second end of the flexible spring, wherein the female fitting is configured to connect to an inspection rod so that a user can push, pull, and rotate the cameral ball via the inspection rod, wherein the female fitting includes a quick release fitting, wherein the quick release fitting includes receiving portion and an aperture defined through an outer wall of the receiving portion, the aperture configured to receive a button lock of a connecting segment of the inspection rod to lock the inspection rod within the receiving portion.

2. The camera ball of claim 1, wherein each of the plurality of protrusions are integrally formed with the two or more portions of the housing body such that each protrusion forms a single piece with a respective portion of the housing.

3. The camera ball of claim 1, wherein the housing body is spheroidal.

4. The camera ball of claim 2, wherein the plurality of protrusions are or include one or more circumferential ribs extending radially outwardly from the housing body, wherein the one or more circumferential ribs are curved along at least a portion of the two or more portions of the housing body.

5. The camera ball of claim 4, wherein the one or more circumferential ribs extend radially outwardly starting from the optical opening, extending circumferentially and ending at a rear location of the housing body.

6. The camera ball of claim 5, wherein the rear location is the rear opening.

7. The camera ball of claim 6, wherein the housing body further comprises one or more light openings between one or more pairs of adjacent circumferential ribs and configured to receive a light.

8. The camera ball of claim 7, wherein the one or more light openings include a light opening disposed between each adjacent pair.

9. The camera ball of claim 8, wherein the one or more light openings are concentrically disposed around the camera opening.

10. The camera ball of claim 1, further comprising an antenna hole defined in a rear side of the housing body and configured to allow an antenna to extend away from a direction of the camera.

11. The camera ball of claim 1, wherein the housing body defines a plurality of interior features configured to nest each internal component therein.

12. The camera ball of claim 1, wherein the two or more portions of the housing body include a front portion and a rear portion, wherein the front portion and rear portion are configured to be attached together, wherein one or more circumferential ribs are formed in the front portion and one or more circumferential ribs are formed in the rear portion are configured to align when the front and rear portions are attached.

13. The camera ball of claim 13, wherein the two or more portions are configured to be fastened together with one or more fasteners.

14. A camera ball system, comprising:
a camera ball, comprising:
a single camera;
a housing body defining a single optical opening for the single camera in a front side of the housing body, wherein the housing body is formed by two or more portions configured to enclose the single camera, wherein the housing body includes a rear opening diametrically opposite the camera opening;
a plurality of protrusions extending outwardly from the housing body, wherein the plurality of protrusions are disposed symmetrically about a center axis of the housing body;
a wireless transceiver operatively connected to the single camera to receive imaging data therefrom;
an attachment member disposed within the rear opening; and
a flexible spring operatively connected to the attachment member and disposed between the attachment member and an inspection rod configured to be connected to the flexible spring, wherein the flexible spring is configured to provide flexibility to at least a portion of an inspection system when navigating turns during inspection, wherein the flexible spring further includes a quick release fitting at an end of the flexible spring opposite the attachment member, wherein the quick release fitting includes an inspection rod receiving portion and an aperture defined through an outer wall of the inspection rod receiving portion, the aperture configured to receive a button lock of the inspection rod to lock the inspection rod within the inspection rod receiving portion, wherein the flexible spring and the inspection rod receiving portion of the quick release fitting are the only components disposed between the attachment member and the inspection rod such that the attachment member and the flexible spring do not provide means for wired connection to the camera ball.

15. The system of claim 14, wherein the connecting segment includes a portion of an inspection rod, an inspection rod fitting, or an inspection rod adapter.

16. A dryer vent inspection system kit, comprising:
a camera ball, comprising:
a single camera configured to capture a live video of an interior of a dryer vent;
a plurality of lights configured to illuminate the interior of the dryer vent during an inspection;
a wireless transceiver configured to transmit the live video from the single camera to a remote device to display the live video;
a forward housing portion having a central hole defined therethrough for receiving a camera lens, a plurality of light apertures defined therethrough and arranged circumferentially about the central opening, and a plurality of ribs defined on the forward housing portion, extending from the central opening to a rear of the forward housing portion, and arranged circumferentially about the central opening, protruding outward from the forward housing portion, wherein the plurality of light apertures are disposed between the plurality of ribs such that the plurality of light apertures and the plurality of ribs alternate in the circumferential direction, the forward housing portion further defining an interior space shaped and configured to receive a portion of the single camera, a portion of the plurality of lights, a portion of the wireless transceiver, and a portion of an electronics assembly therein, wherein the interior space includes a plurality of fastener apertures disposed therein for receiving a respective fastener;
a rear housing portion having a central hole defined therethrough for receiving an attachment member, an aperture defined therethrough for receiving an antenna of the wireless transceiver, an aperture defined therethrough configured for receiving a charging cable to charge the single camera or one or more portions of the electronics assembly, and a plurality of ribs defined on the rear housing portion, extending from the central opening to a rear of the rear housing portion, and arranged circumferentially about the central opening, protruding outward from the rear housing portion, the rear housing portion further defining an interior space shaped and configured to receive a portion of the single camera, a portion of the plurality of lights, and a portion of the electronics assembly, such that when the forward housing portion and the rear housing portion are assembled to one another, the interior space of the forward housing portion and the interior space of the rear housing portion form a camera ball interior to nest and encase the single camera, the plurality of lights, the wireless transceiver, and the electronics assembly therein, wherein the interior space includes a plurality of fastener apertures disposed therein for receiving a respective fastener;
the wireless transceiver operatively connected to the single camera to receive imaging data therefrom and configured to wirelessly communicate the imaging data to the remote device;
the electronics assembly including:
a controller disposed configured to control the single camera, the plurality of lights, the wireless transceiver;
a power switch operatively connected to the controller to turn the controller on or off, the power switch accessible from an outside of a housing body;
a rechargeable battery disposed within the housing body, and
a charging port accessible from the outside of the housing body through the charging aperture;
a plurality of fasteners, each respective fastener extending through a respective fastener aperture of the rear housing portion into a respective fastener aperture of the forward housing portion to secure the rear housing portion to the forward housing portion;
the attachment member partially inserted into the central opening of the rear housing portion and secured with a fastener on the interior of the camera ball such that a portion of the attachment member extends outward from the rear housing portion, wherein the attachment member is a threaded attachment member and the fastener is a threaded fastener threaded onto the attachment member;
a flexible spring having a first end and a second end, the first end threaded onto the attachment member and the second end having a quick release female fitting operatively connected thereto for selectively coupling the inspection system with a plurality of different duct inspection rods or duct inspection rod adapters; and
an inspection rod selectively coupled to the camera ball via the quick release female fitting for maneuvering the camera ball through the interior of the dryer vent during the inspection.

17. The kit of claim 16, wherein the camera ball, the attachment member, and the flexible spring are configured to, together, be selectively removed from and attached to a plurality of different duct inspection rods or duct inspection rod adapters.

18. The kit of claim 17, wherein the plurality of lights are separate from the single camera.
